(19) United States
(12) Patent Application Publication
(10) Pub. No.: US 2009/0012800 A1
(43) Pub. Date: Jan. 8, 2009

(54) COMPUTER-ASSISTED INFORMATION TECHNOLOGY SERVICE DESIGN SYSTEM

(75) Inventors: Murthy V. Devarakonda, Peekskill, NY (US); Hui Lei, Scarsdale, NY (US); Soumitra Sarkar, Cary, NC (US); Axel Tanner, Kilchberg (CH)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 11/773,985

(22) Filed: Jul. 6, 2007

(51) Int. Cl. G06Q 30/00

(52) U.S. Cl. 705/1

(57) ABSTRACT

A method and system are disclosed for providing automated assistance to a service provider for creating a technical solution definition for a project for delivering Information Technology (IT) outsourcing services for a customer. The method comprises the steps of providing, in machine processable form, a definition of a taxonomy of a set of standard services offered by the service provider; providing, in machine processable form, a repository of service designs, each of the service designs describing a set of IT architecture components to deliver a service associated with a standard service element, according to a specified best practice rule; and providing, in machine processable form, a collection of policies that can be executed to validate the service designs selected to deliver the set of contracted services. A computer implemented design tool is used to define the scope of a project a set of service designs, and to run policy-based validation checks on the design.

### BACKGROUND OF THE INVENTION

1. Field of the Invention

This invention generally relates to Information Technology (IT) outsourcing services; and more specifically, the invention relates to creating a technical solution definition for delivering IT outsourcing services.

2. Background Art

Many companies outsource the administration of various aspects of Information Technology (IT) operations, often referred to as Strategic Outsourcing (SO). Aspects of IT operations that are typically outsourced include server management (including management of Web server, databases, etc. running on those servers), storage management, management of hardware assets (e.g., servers, desktops, laptops, PDAs, software licenses), data network management, help desk operations, etc.

Companies that offer IT outsourcing services go through several phases from initial analysis of the customer requirements and environment, through negotiating and signing a contract, eventually to a steady state, managing those aspects of customer IT operations which have been taken over. There is an initial Engagement phase during which the customer requirements are understood and mapped to elements of a taxonomy of standard services offered by the outsourcing company—to define the scope of the deal. A service taxonomy is a hierarchical grouping of the standard services, and the leaf nodes are referred to as service elements. For requirements that cannot be mapped to standard services, custom service elements are defined. The scope, coupled with initial information about the customer environment that is relevant to the deal (e.g., number of servers of different types, amount of storage, etc., if server management and storage management are to be outsourced) is used to create a cost solution, the purpose of which is to forecast the cost to the outsourcing solution over the projected time period of the contract.

During this phase, the technical solution which identifies the target IT architecture—the software tools, middleware and hardware platforms which will be deployed to provide each contracted service, and optionally any planned transformation of the customer IT infrastructure itself—is also defined. Unless every aspect of customer IT operations that is outsourced involves using existing customer tools and hardware, which is rarely the case, the target IT architecture will identify a different IT environment preferred by the outsourcing company to deliver the services with higher operational efficiencies. The cost and technical solutions, along with identification of Service Delivery Obligations (which covers Service Level Agreements and more) are key inputs for creating the contract.

After contract signing, there is a Transition phase during which customer operations (and often their IT personnel) are taken over by the contracting company “as-is”. During this phase, the task of technical solution refinement is performed, using more accurate information about the customer environment available, e.g., by running discovery tools, which are typically permitted only after contract signing. The revised target IT architecture is the basis for creating a transformation solution, which identifies how the current IT environment (tools/software, middleware, hardware) will be gradually replaced. Next comes the Transformation phase during which the IT infrastructure transformation is performed. Finally the phase involving steady state operations starts, during which contracted services are delivered, operations are monitored for compliance with service delivery obligations specified in the contract, and problem determination and resolution are performed.

Many of the activities that are performed during the engagement, transition and transformation phases are carried out manually. One exception is the creation of the cost solution, for which tooling based on machine representation of rate tables and formulae to project the cost of software, hardware, and labor required to deliver various services is essential, since manually performing hundreds of calculations for the scores or hundreds of standard services to which the customer requirements are mapped could be extremely error prone. The related task of scope definition is also supported with tools that expose the architect to the standard services taxonomy, and allow various service elements to be selected, the resulting information being input to the costing tool

On the other hand, the equally important task of technical solution (architecture) definition, both the initial development during the engagement phase, and the subsequent refinement of the solution during the transition phase, is typically documented without any tooling support other than basic word processing tools such as Word and PowerPoint. As a result, there is no consistency in the quality of the work product. Knowledge of best practices, either documented or tribal in nature, is not applied uniformly since the degree to which that is done is highly dependent on the skill of the solution architect, the time she has to document design details, and the availability of a subject matter expert for consultation.

In the domain of IT outsourcing, the use of standard service taxonomies, and the documented service designs, which describe best practices for delivering “atomic” services (corresponding to leaf-level service elements in the taxonomy), is becoming more prevalent in the industry. However, the best practices documentation is typically unstructured and in natural language, and the end goal is simply the harvesting and storing of expert knowledge in a readable, but not machine processable form. While the technical solution design process in current practice may be based on the philosophy of reusing best practices design components, the service composition procedure is essentially manual, and thus errors could be made in selecting the right designs based on analyzing customer requirements, the current state of the IT environment, and even possible future states, and also in checking for composition rules based on dependencies between various service designs.

Building composite entities from piece parts has also been studied actively in the past in the domain of semiconductor technology to automate chip design. The components in that domain are combinations of logic gates, which can be reused in designing different portions of a chipset, which performs a complex and specialized function.

### SUMMARY OF THE INVENTION

An object of this invention is to facilitate outsourcing of Information Technology (IT) operations.

Another object of the present invention is to provide automated assistance for the task of creating a technical solution definition for delivering IT outsourcing services.

A further object of the invention is to define an approach to introduce automation in what is predominantly a manual process for technical solution design in the IT outsourcing industry.

These and other objectives are attained with a method and system for providing automated assistance to a service provider for creating a technical solution definition for a project for delivering Information Technology (IT) outsourcing services to a customer. The method comprises the steps of providing, in machine processable form, a definition of a taxonomy of a set of services offered by the service provider; providing, in machine processable form, a repository of service designs, each of the service designs describing a set of IT architecture components to deliver a service associated with a service element, according to a specified best practice rule; and providing, in machine processable form, a collection of policies which determine when a specific service design can be used and whether a combination of service designs is valid. A computer implemented design tool is used to define a scope of the project, to navigate through said taxonomy, to select a group of service elements for defining a solution for delivering said IT outsourcing services, and to select a set of service designs for delivering those service elements in accordance with best practices.

In a preferred embodiment, the design tool may be used, when none of said set of services is sufficient for a specified task in said project, to create custom nodes in the taxonomy to represent new customer services for performing said task. In addition, in the preferred embodiment, the taxonomy includes intermediate and leaf nodes, and the method comprises the further step of associating with said intermediate and leaf nodes, specific questionnaires that gather information to support requirements analysis, requirements mapping, collection of targeted information to support solution design and tool selection, and the gathering of detailed customer environment information.

The preferred embodiment of the invention, described in detail below, provides automated assistance for the task of creating a technical solution definition for delivering IT outsourcing services. An important principle utilized in the preferred embodiment of this invention is that of IT service composition by reusing component parts, enabling the production of technical solutions, which are more consistent in quality and can be produced with greater efficiency.

The preferred system of this invention uses a number of pieces of information in machine-processable form to provide the automation. For example, this system uses a definition of the taxonomy of standard services offered by the service provider. This may be a hierarchy, and the leaf nodes comprise service elements, which represent the lowest level of granularity at which a service component is defined. The taxonomy definition should be machine-processable. The preferred system also uses a repository of service designs, where each service design describes the IT architecture components—software tools, middleware components, appliances, and hardware—which must be in place to deliver the service associated with a service element, according to a specific best practice that is appropriate for a given customer environment.

In addition, the invention preferably uses a collection of policies, which determine when a specific service design can be used, when a given tool to support one or more designs can be selected, and global constraints, which determine whether a specific composition of services and component designs can be offered together. Service designs form the basis of design level componentization in the IT outsourcing world, and the service taxonomy defines elements which service designs can be associated with. The formal descriptions above can be consumed by the system and interpreted by various execution engines to automate portions of the technical solution creation task in accordance with best practices.

Further benefits and advantages of this invention will become apparent from a consideration of the following detailed description, given with reference to the accompanying drawings, which specify and show preferred embodiments of the invention.

### BRIEF DESCRIPTION OF THE DRAWINGS

FIG. 1 illustrates the architecture of a technical solution design system according to a preferred embodiment of this invention.

FIG. 2 shows a catalog of standard services and designs that may be used in the present invention.

FIG. 3 shows a model of metadata that may be used in this invention.

FIG. 4 is a block diagram of a computer system that may be used in the practice of the present invention.

### DETAILED DESCRIPTION OF THE PREFERRED EMBODIMENTS

The preferred embodiment of this invention is based on a number of principles. The evolving industry practice is for each outsourcing company to standardize on a service taxonomy based on its core competencies, and to document standard designs for leaf nodes of the taxonomy for reuse, instead of building custom solutions for each customer which is not economically sustainable given the intense competition in the industry. Therefore, any tooling preferably leverages the best practices knowledge base. Technical solutions for IT outsourcing typically utilize standard designs (for standard services), or variations of standard designs when a minor customization is warranted. Completely custom designs are more of an exception than the rule. Therefore, a technical solution design tool preferably facilitates identification and reuse of standard designs in a given context whenever possible, and provides simple mechanisms to document technical solutions as deltas on standard designs.

The preferred technical solution design tool is based on a few core execution engines, but it tailors itself dynamically (the refresh period is configurable) based on an external set of metadata repositories which describe, using machine consumable representations, various aspects of service design knowledge that are key to customizing the tool's behavior. All metadata repositories are enabled for queries via remote procedure call (RPC) mechanisms such as (but not limited to) SOAP. The identification of machine consumable metadata associated with service design components, and how a metadata-driven tool can leverage that, is an important aspect of the preferred embodiment of the invention.

The use of relational databases as backend metadata and instance data repositories is an important part of the preferred overall system architecture. The metadata read from external repositories is consolidated and represented in a form optimal for the tool in a metadata repository that is private to the tool. Technical solutions created for different customers are preferably stored in one or more backend repositories, as instance data, which represents technical solutions, created for different outsourcing deals (customers).

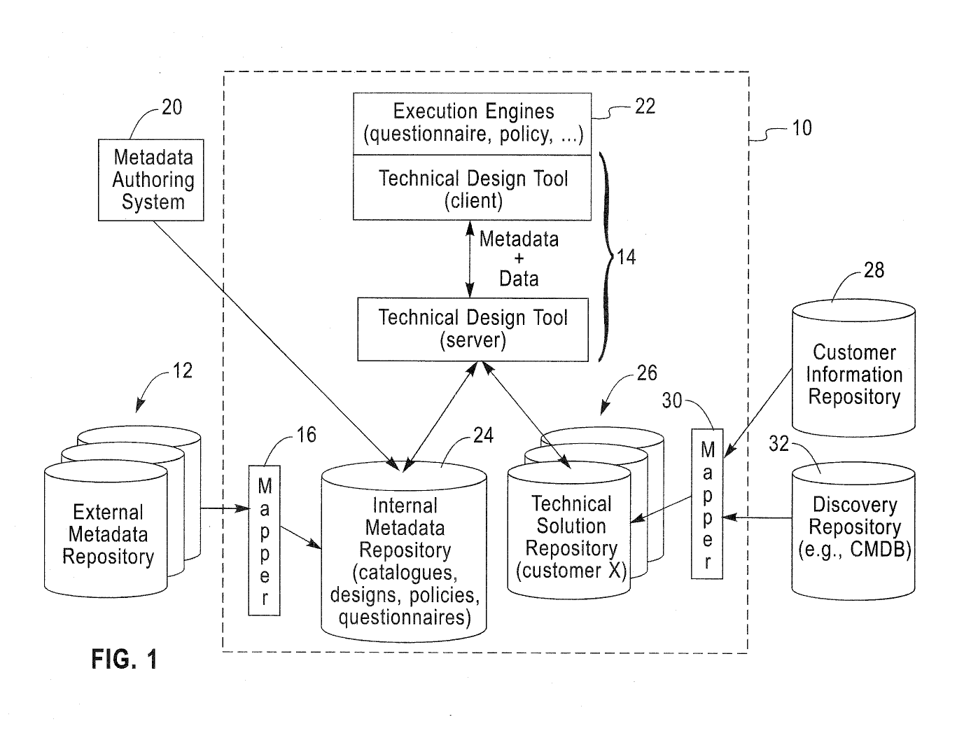

FIG. 1 depicts the preferred overall system architecture 10—showing the key components and the dependencies on external metadata and data sources. Externally defined metadata, represented at 12, (the different types are described below) is read into the system 10 to “prime” the tool 14—via a mapping layer 16 to ensure that the metadata is in a form usable by the design tool. A metadata authoring system 20 allows domain experts to define the “private” metadata, i.e., the metadata used inside the tool, to be added to the internal metadata repository 24 to further customize the tool. An execution engine 22 interprets the metadata to drive tool actions such as the construction of context-specific questionnaires, policy evaluation of architecture compositions, etc.

A set of Technical Solution Repositories 26 store information about solutions created for various contracted services for multiple customers. In earlier phases of the deal, customer environment information that drives the technical solution is input to the tool through questionnaires. In later phases, when customer environment discovery tools can be run, the same “variables” are set by mapping layer 30 by querying the repository 32 populated by such discovery tools, facilitating iterative design refinement and improvement. Information about a customer, such as the customer industry, projected size of the deal, and so on, is also stored in the external Customer Information Repository 28 and is fed into the system through mapping layer 30.

### Metadata Interpreted By the System

Several forms of metadata are key to providing automated support for technical solution design.

Standard Service Catalog and Repository of Best Practice Design

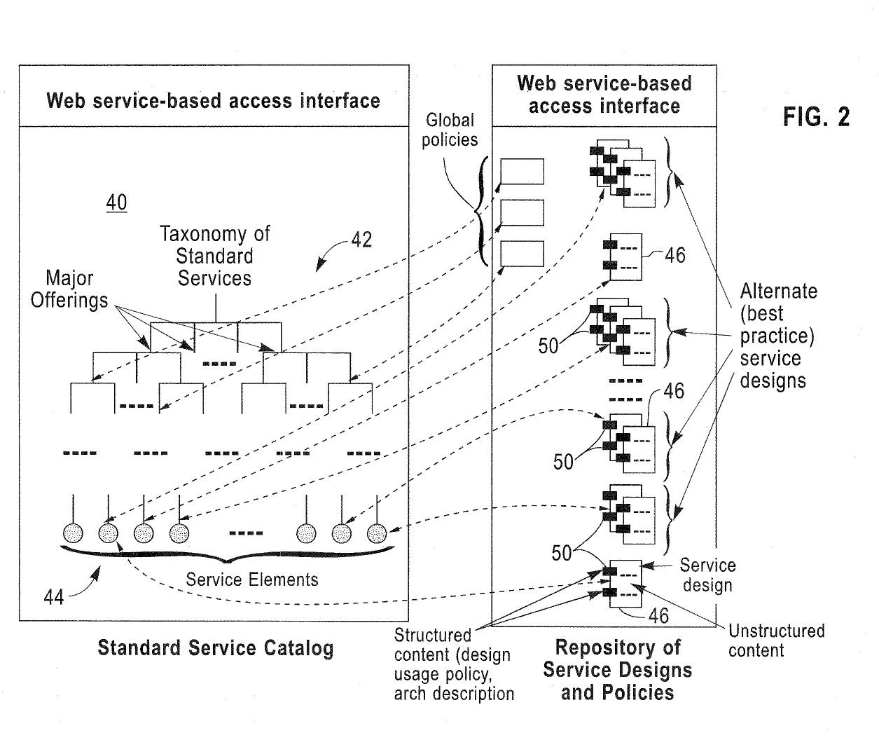

FIG. 2 shows two important categories of metadata used in the preferred embodiment of the system of this invention. The taxonomy of standard services 40 is organized as a hierarchy where the top level nodes under the root represent service offerings 42 (e.g., Mainframe Management, Asset Management, Midrange Server Management, End User Services), whereas the leaf nodes, referred to as Service Elements, 44 represent “atomic” services—such as Windows Server Management, DB2 Database Server Management, etc. under the Midrange Server Management offering. The design repository contains the technical solution definition, which must be implemented to deliver the contracted services to a customer. In the figure, each rectangle 46 represents a service design, the two darkened boxes 50 within each rectangle represent structured (machine-readable information), and the rest (dotted) is unstructured content.

Occasionally, for one service element there can be alternative solutions. For instance, for a service element such as Backup/Restore Services for Midrange Servers, a simple “tar”-based solution might suffice for a few UNIX servers with direct attached tape drives and simple backup and retention policies, whereas a more complex backup/restore environment involving dozens or hundreds of servers and stringent recovery time objectives could warrant the use of an enterprise tape backup/restore system such as Tivoli Storage Manager with centralized robotics-attached tape drives.

Service Design-Related Metadata

With the preferred system, three key pieces of knowledge captured in each service design are represented formally:

1. Policies that govern when a standard design can be used. There are various sub-flavors of such policies, which are described below.

2. Global policies defining service (scope) selection dependencies.

3. A description of the architectural components that is required to implement the service design.

The actual representation language for each type of metadata is not critical to this invention. A notation comprised of custom XML tags which can express the semantics of design selection policies will suffice for issues #1 and #2, and a different set of XML tags to represent information about software tools and middleware components (e.g., databases and J2EE servers) required to provide the service, and hardware components on which such software should preferably run, will suffice for issue #3. Alternatively, existing formalisms can be leveraged, such as the wide variety of rule/policy formalisms which have been described in the literature for issues #1 and 2, and formalisms such as Common Information Model Managed Object Framework (CIM-MOF) from the Data Modeling Task Force (DMTF), or SysML from the Object Management Group (OMG), for issue #3—though ad hoc extensions to CIM-MOF primitives will be required to represent software entities. What is important, in the preferred implementation of this invention, however, is the identification of the semantics of policies and of architectural descriptions, which are formally represented, and how the tool can utilize such descriptions (independent of the choice of language) to provide automated support for technical solution design. These are discussed below.

Each of the three (3) above-identified pieces of knowledge will now be discussed in detail.

### 1. Policies Governing Service Design Use

There are several types of policies that can be associated with a service design. These policies include design selection policies and design constraints.

A set of design selection policies is to enable determination of whether a design can be used at all. For example, there can be a standard design for the service element “Windows server management” which describes the suite of tools used to perform remote systems management, provide health monitoring and reports, or push operating system updates to the servers, etc. However, the standard design may not apply for one or more Windows servers which are running as Citrix servers. The selection policy would explicitly rule out use of that service design for the Citrix servers. In this case, if there is no (other) service design for Citrix server management, a custom design will have to be created.

A set of design constraints is specified as a means to determine if a service design can be used as-is. If any one of the constraints is not met, then the design should be customized. For example, there can be a standard design for the service element “DB2 Logical Database Server Administration” describing tools used to support various facets of the service that is provided. One of the constraints of the standard design could be that each DB server must be configured to run with at least 25% free space. If that constraint is not met in a given customer environment, then the standard design can be used but must be customized for that environment with details regarding additional procedures, tools and operational limitations warranted due to the free space restriction.

### 2. Service Dependencies and Scope Selection—Global Policies

The service design repository also contains policies that are more “global” in nature than those discussed above regarding the use of a specific service design. Examples of such policies could involve dependencies between different service elements that are selected to be in scope, or constraints regarding when certain service elements can or must be in scope—as illustrated below.

For example, under the Asset Management offering, there could be a policy that the Software License Management service element cannot be selected (be part of the scope definition) unless the Hardware Inventory Tracking and Software Inventory Tracking service elements are also in scope. Another policy could be that the Software Inventory Tracking service element must be in scope if the customer environment will have, for example, IBM-owned assets under the outsourcing agreement.

Such policies are not associated with a specific service design, and unlike service designs, may be associated with an element in the service taxonomy that is at a higher level in the tree than a service element.

### 3. Architectural Components and Tool Selection Policies

Associated with each service design is a high level description of the tools (software and middleware) and hardware components (e.g., servers for running the software and middleware, or appliances) required to deliver the service. This is simply an inventory list and not a detailed description of interconnections and topology. For instance, for delivering the Storage Management service element, the standard service design could specify the following architecture components: one or more copies of the TotalStorage® Productivity Center (TPC) storage infrastructure management tool; one or more servers to run TPC, and a list of valid platforms; a copy of DB2 for persisting discovered information about a Storage Area Network (SAN); and a server to run DB2 and a list of valid platforms.

For very large SANs, multiple copies of TPC running on multiple servers might be required, but for the purpose of this definition, the exact number of copies (which can only be determined by an analysis of the storage environment size and the storage management service SLAs) is not critical.

The description of hardware components is not limited to machines, network equipment or storage required to run software tools and middleware to support the service. For example, for the server management service (an intermediate node in the taxonomy), certain service designs for taxonomy elements under that service might require that the customer runtime environment itself be transformed—say from Sun servers running Solaris to Intel servers running Linux. That target hardware environment is defined separately, and referenced in architecture descriptions of all service designs that assume such a transformation of the core infrastructure.

At a more global level than a service design (or service element), tool selection policies must be specified when a commonly used capability can be delivered by several alternative tools, and the best selection(s) is determined by customer requirement and environment considerations. For example, several service elements under the Asset Management offering—e.g., Software Asset Tracking, Software License Management, and Hardware Asset Tracking—require the selection of a scanning tool. Several alternative tools may exist, and the best choice is determined by the combination of services that are in scope as well as details about the customer environment. For example, one tool may not be able to scan UNIX machines and will have to be ruled out if UNIX machines have to be tracked, though that tool might be the best option in a Windows-only environment.

### Representation of Policies and Constraints, and Related Metadata

Several of the representational elements discussed above involve the definition of policies or “rules” that determine whether a best practices design can be used, whether it must be customized before use, what tools should be used in the delivery of a service, and so on. A policy is a condition-action rule. The condition component of a policy is a predicate which is a logical expression (in the programming language sense) comprised of a number of variables. In IT service design; several types of variables are sufficient to represent the semantics of policy preconditions, including Scope, Solution Guidance Input (SGI) variables, and Customer Information (CInfo) variables.

Scope represents the mapping of customer requirements to standard services in the taxonomy, which have been selected by the technical solution architect. Solution Guidance Input (SGI) variables represent different types of customer environment information (e.g., IT infrastructure information such as number of DB2 database servers, IT policies such as firewall policies for external access by IT service providers, etc.). An SGI variable is associated with a specific element of the service taxonomy, but its position in the hierarchy only affects how it is uniquely named, and not which predicates can access its value. Customer Information (CInfo) variables represent non-IT environment information such as the customer's industry, number of locations, revenue, projected service opportunity, etc.

The “action” part of a policies used for guiding service design is always implicit. If the precondition of a policy is true, then the design or tool selection, the design constraint, or the choice of scopes against which the policy was applied is valid.

### Questionnaires

To evaluate policies with preconditions, values of SGI variables have to be set, and in initial phases of design, the only mechanism available is to present to the solution architect a list of variables in the form of a questionnaire to be filled in. Questionnaires containing a list of SGI variables whose values are to be set are referred to as sequential questionnaires. Sequential questionnaires can be represented using a set of XML tags around each SGI variable whose value is to be solicited, and can be used by a questionnaire execution engine (described below) to control the display. Some questionnaires can be automatically generated from other forms of metadata, and are also described below. However, other questionnaires can only be manually added to the system and provide additional degrees of design automation support, as described below.

### Manually Created Questionnaires

As shown in FIG. 1, the system includes a metadata authoring system for defining custom questionnaires, the intent of which could be to collect information not directly related to service design and tool selection for technical solution design.

In the IT outsourcing services business, questionnaires are used in various phases of customer requirements analysis and solution design—e.g., to guide analysis of the Request for Proposal (RFP) document, or to create a detailed inventory of the customer's IT equipment and software prior to contract signing. The intent of these questionnaires is not to guide the service design selection process, but many of the questions deal with the very same SGI variables that can help design selection. Using the system's common questionnaire representation and execution capabilities plus the backend repository to store solution data (answers), it is possible to consolidate several aspects of the pre- and post-design phase activities, such as requirements analysis and technical due diligence, performed by multiple role players, into an integrated system, thereby reducing duplicate and redundant work.

### Decision Trees

Decision trees in the context of the technical solution design tool are questionnaires with conditional logic that controls the flow of questions. Unlike sequential questionnaires where all questions are presented together, in a decision tree questionnaire, the next question asked could depend on the answers given to questions asked in the past. Representation of a decision tree questionnaire can be formalized by a relatively simple extension of the scheme used to represent sequential questionnaires, e.g., by introducing special XML tags to represent conditional logic, where the if-condition is a predicate consisting of SGI variables only.

Questionnaires automatically derived from service design metadata do not contain control flow logic. However, manually created decision tree questionnaires are useful for automation in a different context. One aspect of best practices documentation that is prevalent in the industry is the description of logic to guide the mapping of customer requirements to one or more services in the service taxonomy. This requirements mapping exercise is performed early in the technical solution definition process, to define the scope before solution detailing via service design composition is performed. Such decision-making knowledge is typically documented using flow charts, recorded using a drawing tool such as Visio, set forth, and is intended as education material for a solution architect. In the preferred system of the present invention, a questionnaire can be created with control flow logic to provide machine assistance to traverse the decision tree to lead to the final mapping, as a result of which not only is the final mapped scope recorded in the repository, but so are the intermediate decisions steps as values of SGI variables.

### Questionnaire Preconditions

It is sometime useful to control the questionnaires that are made visible to the technical solution designer, depending on various conditions. For example, questions that get into a level of detailed solution design appropriate for enterprise customers may not be appropriate for technical solutions created for small-medium business (SMB) customers. Predicates based on appropriate variables (e.g., CInfo variables) can be used to partition questionnaires into different sets, and their visibility to the solution designer can thus be controlled.

### System Runtime

### Execution Engines

The preferred system of the present invention has a number of execution engines for interpreting the different types of metadata to provide customized assistance during technical solution design. These execution engines include a questionnaire interpretation engine, a policy execution engine, and an architecture composition engine.

The questionnaire interpretation engine controls the display of questions on a graphical user interface (GUI), shows default values, collects inputs for some or all of the variables, and stores them in a repository. The engine handles both sequential questionnaires and decision trees. The policy execution engine evaluates predicates associated with design selection, tool selection, and global policies and reports policy violations. The architecture composition engine combines the architecture components associated with each service design and creates a consolidated view of the target IT architecture, identifying duplication and opportunities for consolidation of software, middleware and hardware components, which can be the starting point of transformation planning.

### Mapping Elements

Several mapping elements 16, 30 are depicted in FIG. 1: Architecture of Technical Solution Design System. There are two categories of mapping elements, one which maps metadata into a form that can be interpreted by the system, and the other which maps the contents of external databases into values of specific system variables which are initially populated by questionnaires and which are used to evaluate policy preconditions.

### Metadata Mapping

One form of metadata mapping involves the transformation of SGI variables, identified in predicates of policies associated with service design usage and tool selection, into a set of sequential questionnaires to capture their values. The mapping infrastructure can support other types of external metadata also.

For example, parameters of formal models corresponding to various types of obligations, associated with different types of services represented in the service taxonomy (e.g., backup and restore or high availability), have to be eventually collected and recorded to enable monitoring of the right information during steady state (delivery). A mapping component can be built to access and parse a model definition corresponding to a given contractual obligation for a service element, generate new SGI variable definitions (or with human assistance, reuse existing variables as applicable) corresponding to the attributes of each object in the model, and generate a sequential questionnaire associated with that service element to collect values of those variables to capture obligations parameters.

### Mapping Customer Information to Model Attributes

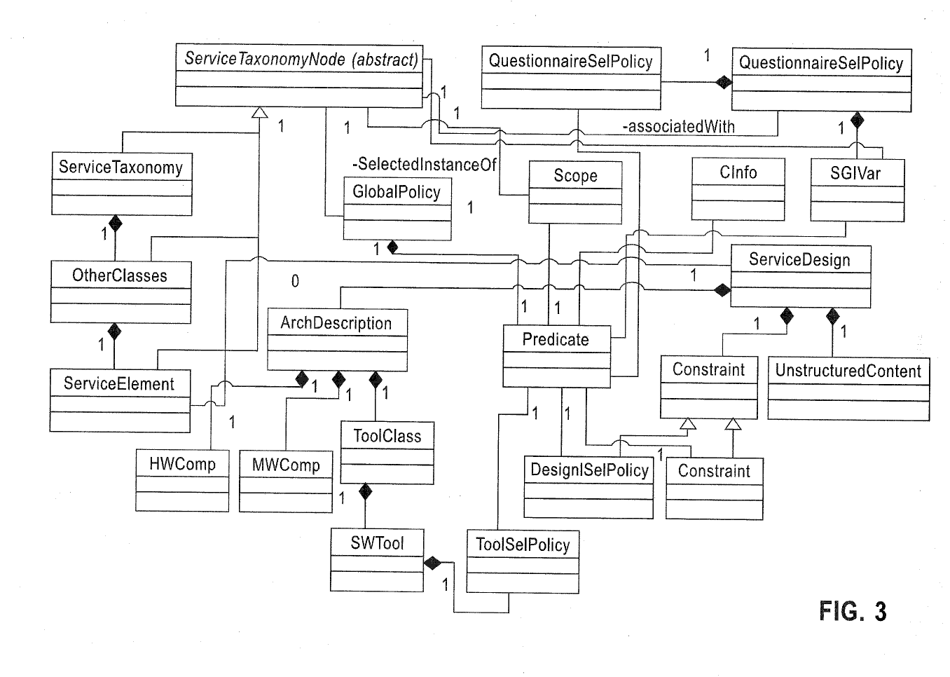

Mapping components can also be built to implement associations between instances of the metadata model of FIG. 3 representing real world information, and data available in various databases maintained either in the customer environment or by the outsourcing service provider. Values of CInfo variables which can appear in policy predicates represent information about the customer that is maintained by the service provider—such as the customer's name, industry, location(s), revenue, etc. A more elaborate mapping captures the relationship between various SGI variables defined in the system metadata to contents of a runtime database which stores information about the customer's IT environment—software, middleware, hardware, etc.—populated by running discovery tools, and sets SGI variable values by querying the database. One example of such a database is the Configuration Management Database (CMDB) that is an integral part of the IT Service Management (ITSM) standards widely accepted in the industry. Such a database may not exist in the customer environment during early phases of requirements analysis and solution design, and therefore, solution design proceeds with manually input values of SGI variables which might represent incorrect information about the customer environment. However, after the contract is signed, the outsourcing service provider can install a CMDB and supporting discovery tools, use the mapping component to populate some of the SGI variables with more accurate values, and then run another iteration of the design process—as part of the solution maturing step.

### End-User View of the System

This section describes one (of several) possible ways in which technical solution architects can interact with the technical solution design tool described above to more efficiently build a consistently higher quality technical solution based on documented best practices, than would be possible using word processing and drawing tools alone.

The tool provides a basic user interface for defining scope, allowing navigation of the standard services taxonomy and selection of service elements (leaf nodes) which can deliver function to match various customer requirements. Custom nodes can be created in the taxonomy—for a specific account only (i.e., it does not alter the standard taxonomy)—to represent custom services which are necessary since no standard service is sufficient. A completely custom design is associated with such a custom node in the taxonomy. The tool extends these interaction modes based on metadata interpretation.

Associated with intermediate and leaf nodes, there preferably are context-specific questionnaires that gather information to support requirements analysis, requirements mapping (via decision trees), collection of targeted information to support solution design or tool selection, or the gathering of detailed customer environment information—where the latter information may not be (made) available until late in the design phase when a contractual agreement is imminent. Certain questionnaires may be only conditionally presented across deals, depending on customer details.

For service elements, a specialized user interface (UI) allows the solution designer to document the technical solution appropriate for that service element while leveraging the repository of standard service designs. The UI provides several broad capabilities to assist the design definition and optional customization task.

The UI provides the capability for examining all service designs for a service element. The UI also provides the capability of viewing of system recommendations based on evaluation of service design selection policies and constraints, in terms of a system-created categorization of service designs into those that are not recommended, those that can be used with some customization, and those that can be used as-is.

In addition, the UI provides the ability to view the values of all variables (scope, CInfo, SGI variables) which appear in at least one selection policy or constraint for a design associated with that service element. This provides visibility into the system decision, and exposes potentially important information which might have been inadvertently omitted (in a questionnaire) resulting in the system not being able to recommend any service design. Other capabilities provided by the UI include the ability to override system recommendations—e.g., by customizing a standard design even if the tool recommends that the standard design can be used as-is, and the ability to reference a standard design and record the deltas.

The tool provides a policy validation checking option. While none of the design selection, tool selection or global policies is enforced in any way, the validation step creates a report that documents all policies and constraints whose predicates are evaluated to false. This includes the global validation of the overall service (design) composition and is useful for design reviews. Also, a separate report generates a consolidated architecture view based on the component service designs in the composite design for each high level node in the service taxonomy.

A technical solution document can be generated from the inputs provided to the tool, where the service definition hierarchy can be the basis of generating a hierarchical document structure with chapters, sections, subsections, etc. The design annotations (references to standard designs—URLs—and customizations of the same) form the bulk of the document content, and the values of SGI variables, which provide the rationale for the design choices, form another major component of the document.

For a scenario where a large portion of the technical solution can be composed from standard service designs alone, the design documentation process can be sped up considerably by simply agreeing with the tool recommendation for all service elements where the standard design suffices, the only additional effort required being to fill out the questionnaires.

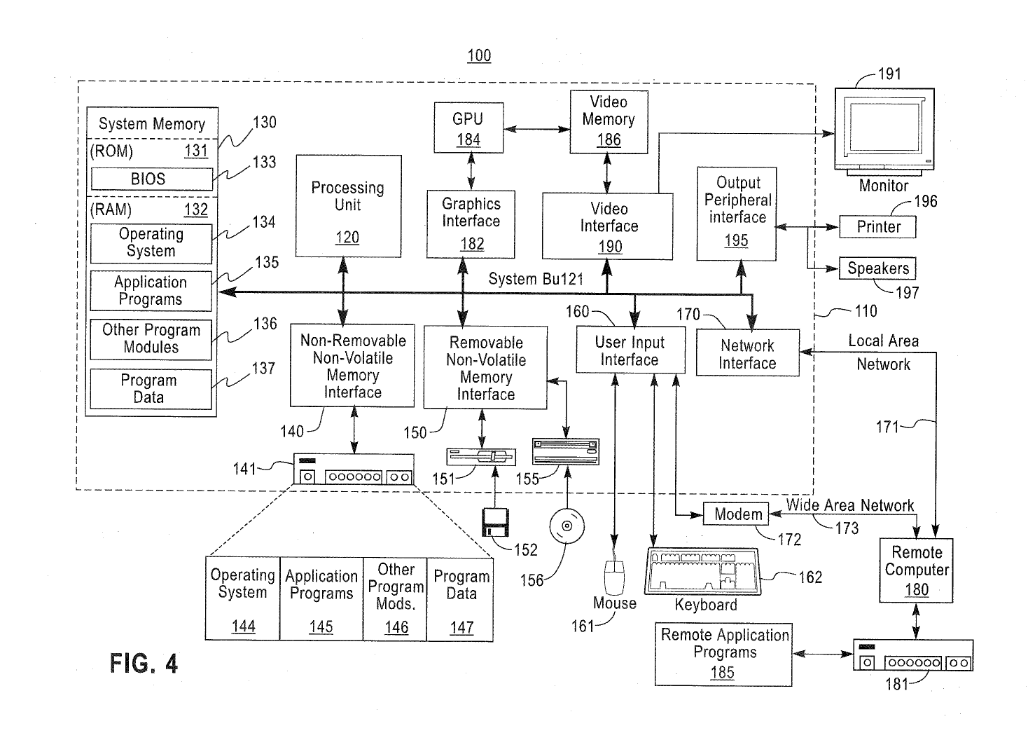

The method of the present invention will be generally implemented by a computer executing a sequence of program instructions for carrying out the steps of the method and may be embodied in a computer program product comprising media storing the program instructions. For example, FIG. 4 and the following discussion provide a brief general description of a suitable computing environment in which the invention may be implemented. It should be understood, however, that handheld, portable, and other computing devices of all kinds are contemplated for use in connection with the present invention. While a general-purpose computer is described below, this is but one example, the present invention may be implemented in an environment of networked hosted services in which very little or minimal client resources are implicated, e.g., a networked environment in which the client device serves merely as a browser or interface to the World Wide Web.

Although not required, the invention can be implemented via an application-programming interface (API), for use by a developer, and/or included within the network browsing software, which will be described in the general context of computer-executable instructions, such as program modules, being executed by one or more computers, such as client workstations, servers, or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations. Other well known computing systems, environments, and/or configurations that may be suitable for use with the invention include, but are not limited to, personal computers (PCs), server computers, hand-held or laptop devices, multi-processor systems, microprocessor-based systems, programmable consumer electronics, network PCs, minicomputers, mainframe computers, and the like. The invention may also be practiced in distributed computing environments where tasks are performed by remote processing devices that are linked through a communications network or other data transmission medium. In a distributed computing environment, program modules may be located in both local and remote computer storage media including memory storage devices.

FIG. 4, thus, illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 4, an exemplary system for implementing the invention includes a general purpose-computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 4 illustrates operating system 134, application programs 135, other program modules 136, and program data 137.

The computer 110 may also include other removable/non-removable, volatile/nonvolatile computer storage media. By way of example only, FIG. 4 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 4 provide storage of computer readable instructions, data structures, program modules and other data for the computer 110. In FIG. 4, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB).

A monitor 191 or other type of display device is also connected to the system bus 121 via an interface, such as a video interface 190. A graphics interface 182, such as Northbridge, may also be connected to the system bus 121. Northbridge is a chipset that communicates with the CPU, or host-processing unit 120, and assumes responsibility for accelerated graphics port (AGP) communications. One or more graphics processing units (GPUs) 184 may communicate with graphics interface 182. In this regard, GPUs 184 generally include on-chip memory storage, such as register storage and GPUs 184 communicate with a video memory 186. GPUs 184, however, are but one example of a coprocessor and thus a variety of co-processing devices may be included in computer 110. A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 4. The logical connections depicted in FIG. 4 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 4 illustrates remote application programs 185 as residing on memory device 181. It will be appreciated that the network connections shown are exemplary and other means of establishing a communications link between the computers may be used.

One of ordinary skill in the art can appreciate that a computer 110 or other client device can be deployed as part of a computer network. In this regard, the present invention pertains to any computer system having any number of memory or storage units, and any number of applications and processes occurring across any number of storage units or volumes. The present invention may apply to an environment with server computers and client computers deployed in a network environment, having remote or local storage. The present invention may also apply to a standalone computing device, having programming language functionality, interpretation and execution capabilities.

As will be readily apparent to those skilled in the art, the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized.

The present invention, or aspects of the invention, can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. A method for providing automated assistance to a service provider for creating a technical solution definition for a project for delivering Information Technology (IT) outsourcing services to a customer, the method comprising the steps of:
providing, in machine processable form, a definition of a taxonomy of a set of services offered by the service provider;
providing, in machine processable form, a repository of service designs, each of the service designs describing a set of IT architecture components to deliver a service associated with a service element, according to a specified best practice rule;
providing, in machine processable form, a collection of policies which determine when a specific service design can be used; and
using a computer implemented design tool to define a scope of the project, to navigate through said taxonomy, and to select a group of service elements for defining a solution for delivering said IT outsourcing services.

2. A method according to claim 1, wherein the step of using the computer implemented design tool includes the step of using the design tool, when none of said set of services is sufficient for a specified task in said project, to create custom nodes in the taxonomy to represent customer services for performing said task.

3. A method according to claim 1, wherein the taxonomy includes intermediate and leaf nodes, and the method comprises the further step of associating with said intermediate and leaf nodes, specific questionnaires that gather information to support requirements analysis, requirements mapping, collection of targeted information to support solution design and tool selection, and the gathering of detailed customer environment information.

4. A method according to claim 1, comprising the further step of automatically importing to a technical solution repository customer information from an external customer information repository using a mapper.

5. A method according to claim 4, wherein the importing step includes the step of inputting said customer information to the technical solution repository through the mapper to ensure that the input information is in a form usable by the design tool.

6. A method according to claim 1, wherein the using step includes the step of providing the computer implemented design tool with a plurality of execution engines for interpreting the different types of metadata to provide customized assistance during technical solution design.

7. A method according to claim 6, wherein the plurality of execution engines includes a policy execution engine to evaluate predicates associated with design selection, tool selection and global policies.

8. A method according to claim 6, wherein the plurality of execution engines includes an architecture composition engine to combine the architecture components associated with each service design and to create a consolidated view of the target IT architecture.

9. A system for providing automated assistance to a service provider for creating a technical solution definition for a project for delivering Information Technology (IT) outsourcing services for a customer, the system comprising:
a first metadata repository for providing, in machine processable form, a definition of a taxonomy of a set of services offered by the service provider;
a second metadata repository for providing, in machine processable form, a plurality of service designs, each of the service designs describing a set of IT architecture components to deliver a service associated with a service element, according to a specified best practice rule;
a third metadata repository for providing, in machine processable form, a collection of policies which determine when a specific service design can be used; and
a computer implemented design tool to define a scope of the project, to navigate through said taxonomy, and to select a group of service elements for defining a solution for delivering said IT outsourcing services.

10. A system according to claim 9, wherein the design tool includes code for creating custom nodes in the taxonomy to represent customer services for performing said task when none of said set of services is sufficient for a specified task in said project.

11. A system according to claim 9, wherein the taxonomy includes intermediate and leaf nodes, and the design tool includes code for associating with said intermediate and leaf nodes, specific questionnaires that gather information to support requirements analysis, requirements mapping, collection of targeted information to support solution design and tool selection, and the gathering of detailed customer environment information.

12. A system according to claim 9, further comprising a technical solution repository for storing, in machine processable form, information about solutions created for various contracted services for multiple customers.

13. A system according to claim 9, further comprising a mapper, and wherein information is read into the internal metadata repository from the external metadata repository via a mapper, and said mapper ensures that the input information is in a form usable by the Technical Design tool.

14. A system according to claim 9, wherein:
the design tool includes a plurality of execution engines for interpreting the different types of metadata to provide customized assistance during technical solution design; and
the plurality of execution engines includes:
i) a questionnaire interpretation engine to control the display of questions to the customer on a graphical user interface, to show default values for questions used in the questionnaire, and to collect input for some or all of the variables used in said questionnaire;
ii) a policy execution engine to evaluate predicates associated with design selection, tool selection and global policies; and
iii) an architecture composition engine to combine the architecture components associated with each service design and to create a consolidated view of the target IT architecture.

15. A program storage device readable by machine, tangibly embodying a program of instructions executable by the machine to perform method steps for providing automated assistance for creating for a service provider a technical solution definition for a project for delivering Information Technology (IT) outsourcing services for a customer, said method steps comprising:
providing, in machine processable form, a definition of a taxonomy of a set of services offered by the service provider;
providing, in machine processable form, a repository of service designs, each of the service designs describing a set of IT architecture components to deliver a service associated with a service element, according to a specified best practice rule; providing, in machine processable form, a collection of policies which determine when a specific service design can be used; and
using a computer implemented design tool to define a scope of the project, to navigate through said taxonomy, and to select a group of service elements for defining a solution for delivering said IT outsourcing services.

16. A program storage device according to claim 15, wherein the step of using the computer implemented design tool includes the step of using the design tool, when none of said set of services is sufficient for a specified task in said project, to create custom nodes in the taxonomy to represent customer services for performing said task;

17. A program storage device according to claim 15, wherein the taxonomy includes intermediate and leaf nodes, and the method steps comprise the further step of associating with said intermediate and leaf nodes, specific questionnaires that gather information to support requirements analysis, requirements mapping, collection of targeted information to support solution design and tool selection, and the gathering of detailed customer environment information.

18. A program storage device according to claim 15, wherein said method steps comprise the further step of automatically importing to a technical solution repository customer information from an external customer information repository using a mapper.

19. A program storage device according to claim 18, wherein the importing step includes the step of using the mapper to ensure that the input information is in a form usable by the design tool.
